(19) United States
(12) Patent Application Publication
(10) Pub. No.: US 2020/0192106 A1
(43) Pub. Date: Jun. 18, 2020

(54) LASER SYSTEM WITH INCREASED LASER ENERGY WHILE MAINTAINING LOW LASER CLASSIFICATION

(71) Applicants: Bradley Short, Goleta, CA (US); Jacob A. Bergam, Santa Barbara, CA (US); Sean H. Ross, Santa Barbara, CA (US)

(72) Inventors: Bradley Short, Goleta, CA (US); Jacob A. Bergam, Santa Barbara, CA (US); Sean H. Ross, Santa Barbara, CA (US)

(73) Assignee: Continental Automotive Systems, Inc., Auburn Hills, MI (US)

(21) Appl. No.: 16/217,741

(22) Filed: Dec. 12, 2018

(51) Int. Cl. G02B 27/09; H01S 3/16; G01S 7/481; G01S 17/93

(52) U.S. Cl. CPC G02B 27/095; H01S 3/1611; G01S 17/936; G01S 7/4814; H01S 3/1643

(57) ABSTRACT

A laser system includes a laser module that generates a laser input beam. A first beam divergence structure is constructed and arranged to receive the laser input beam and to expand the laser input beam to a diverging beam. A second beam divergence structure is separate from and spaced from the first beam divergence structure. The second beam divergence structure is constructed and arranged to receive the diverging beam from the first beam divergence structure, creating an extended source, and to expand the diverging beam further into an output beam that illuminates an area. The second beam divergence structure defines a plane that a human eye cannot effectively see past so that the laser system can operate at higher power while maintaining a low laser classification.

### FIELD

This invention relates to advanced driver assist systems or autonomous driving vehicles using a laser system and, more particularly, to a low laser classification (e.g., Class 1) laser system with increased power.

### BACKGROUND

A laser system must be classified for danger due to radiation exposure. A Class 1 laser is safe under all conditions of normal use. This means the maximum permissible exposure (MPE) cannot be exceeded when viewing a laser with the naked eye and with aided optics. With reference to FIG. 1, a conventional Class 1 laser system is shown, generally indicated at 10, having a laser module 12 and a single diffuser 14 that expands the input beam 16 by giving it a high divergence. Eye safety of an extended source 18 is better than a point source since an extended source is not focused on the retina. However, for flash LIDAR systems, it is challenging to provide a single laser with fixed position and with a single diffuser that has enough energy for the system to sense at acceptable ranges while also keeping the system in an acceptable laser classification for open use.

Thus, there is a need to provide a laser system that increases the maximum laser energy allowed, while still being considered a low classification laser, so as to provide a higher power laser.

### SUMMARY

An objective of the invention is to fulfill the need referred to above. In accordance with the principles of an embodiment, this objective is achieved by a laser system that includes a laser module constructed and arranged to generate a laser input beam. A first beam divergence structure is constructed and arranged to receive the laser input beam and to expand the laser input beam to a diverging beam. A second beam divergence structure is separate from and spaced from the first beam divergence structure. The second beam divergence structure is constructed and arranged to receive the diverging beam from the first beam divergence structure, creating an extended source when incident on the second divergence structure, and to expand the diverging beam further into an output beam that illuminates an area. The second beam divergence structure defines a plane that a human eye cannot effectively see past so that the laser system can operate at higher power while maintaining a low laser classification.

In accordance with another aspect of an embodiment, a method provides a laser system with maximum allowable laser energy. The method provides a laser module that generates a laser input beam. The laser input beam is expanded by a first divergence structure into a diverging beam. A second beam divergence structure receives the diverging beam, creating an extended source when incident on the second beam structure, and expands the diverging beam further into an output beam that illuminates an area. The second beam divergence structure is separate from and spaced from the first beam divergence structure and the second beam divergence structure defines a plane that a human eye cannot effectively see past.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic view of a conventional Class 1 laser system showing laser beam inputted to a single diffuser resulting in an expanded uniform output beam.

FIG. 2 is a schematic view of a laser system of an embodiment showing a laser input beam sent to a first, high angle diffuser which is then expanded further by a second, low angle diffuser into an output beam.

FIG. 3 is a schematic view of a laser system of another embodiment showing a laser input beam sent to a first, low angle diffuser which is then expanded further by a second, high angle diffuser into an output beam.

FIG. 4 is a schematic view of a laser system of another embodiment showing a laser input beam sent to a beam expander which is then expanded further by a high or low angle diffuser into an output beam.

FIG. 5 is a perspective view of a vehicle having a LIDAR sensor including the laser system of an embodiment.

### DETAILED DESCRIPTION OF EXEMPLARY EMBODIMENTS

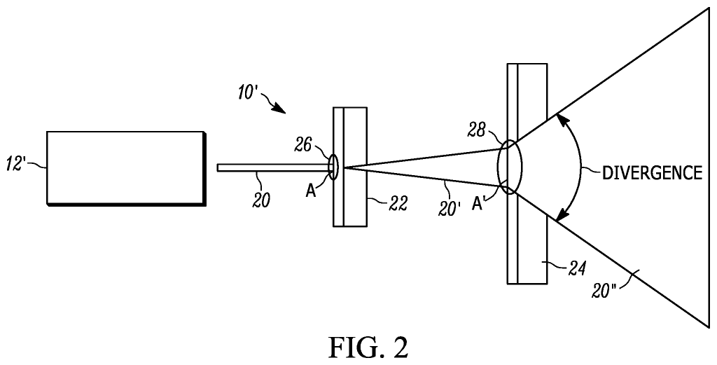

With reference to FIG. 2, a laser system is shown, generally indicated at 10′, in accordance with an embodiment. The laser system 10′ includes a laser module 12′ preferably having the conventional diode, coupling optics, ND:YAG crystal, and, if needed, filter glass to filter out the diode light. However, the system 10′ can employ any laser source. This includes all DPSSL lasers which typically have small laser source sizes that would benefit from the system 10′. Also, a laser diode could be used as the light source such as edge emitters, VCSEL, or any laser diode. In operation, the laser module 12′ generates a laser input beam 20 that hits, or is received by, a first beam divergence structure such as a high angle diffuser 22 where it refracts, scatters and/or diffracts into a diverging beam 20′. Next, the diverging beam 20′ hits, or is received by, a second beam divergence structure creating an extended source when incident on the second divergence structure. The second divergence structure can be a second diffuser that is preferably a low angle diffuser 24 which causes further divergence of the diverging beam 20′. Upon passing through the low angle diffuser 24, the output beam 20″ continues to expand and illuminate the area in front of the system 10′. As seen, the low angle diffuser 24 is separate from and spaced axially downstream from the high angle diffuser 22. As used herein, “diffuser” is defined as a micro-optic or nano-optic structure that can produce a desired illumination pattern from a given input light source. A diffuser can include, for example, a refractive element, a diffractive element, a hybrid element, a ground glass element, a plastic element, or any other element that meets the definition.

FIG. 2 shows a surface area A, within oval 26, of the input beam 20 on a surface of the first diffuser 22. Surface area A′, within oval 28, of the diverging beam 20′ on a surface of the second diffuser 24 is much larger than that of area A due to expansion of the input beam 20 through the diffuser 22. The diverging beam 20′, with larger surface area, is the extended source input to the second diffuser 24 which expands the beam even greater to define the output beam 20″.

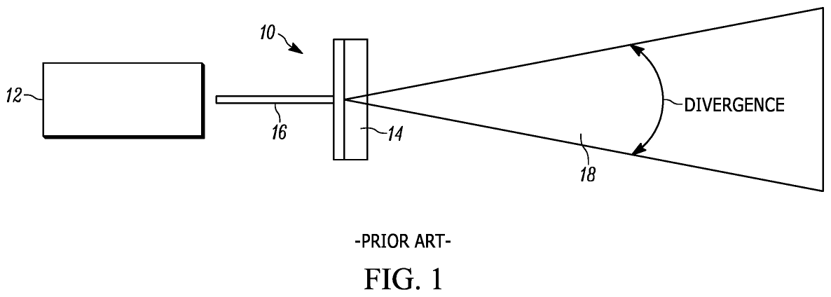

The addition of the second diffuser 24 provides a plane that the human eye cannot effectively see past. This means that when considering the laser classification, one considers the expanded beam area A′ on the second diffuser 24, not the smaller input beam area A on first diffuser 22. Consequently, the maximum laser energy allowed while still considering system 10′ to be a low laser classification (e.g., Class 1) increases and thus the laser module 12′ can have much higher power. The use of the second diffuser in system 10′ could allow for any arbitrary power increase needed, restricted only by total package size and potentially the size of the diffuser used. In the embodiment, the system 10 provides at least 3 orders of magnitude greater energy than the conventional system 10 (FIG. 1) while maintaining Class 1 status.

In the embodiment of FIG. 2, the high angle diffuser 22 is used as the first beam divergence structure to reduce the system path length significantly and the low angle diffuser 24 is the second beam divergence structure. This increases the overall system efficiency and significantly reduces system length. The low angle diffuser 24 is generally less sensitive to angular misalignment and can be generated for different input angles (e.g., Fresnel elements). This can reduce the loss of the overall system 10′. Putting the high angle as the first diffuser 22 allows for the system to be shorter and still having a low energy density on the second diffuser 24.

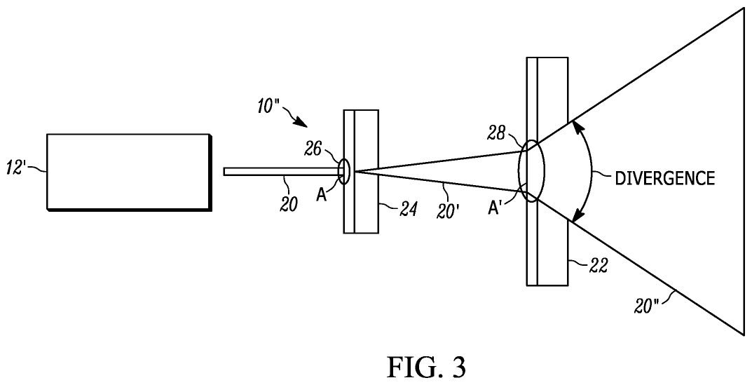

However, with reference to FIG. 3, another embodiment of the system 10″ is shown with the low angle diffuser 24 used as the first beam divergence structure and with the high angle diffuser 22 used as the second beam divergence structure. The high angle diffuser 22 is more dependent to the input beam angle, and having an expanding beam hit the high angle diffuser 22 results in loss and shape distortion. Therefore, using a collimated beam with the first diffuser 24 and then placing a second diffuser 22 after the first diffuser 24 produces the highest system shaping accuracy and throughput. This also reduces the system length, which means the LIDAR sensor employing the system 10″ can be shorter and lighter. Similar to FIG. 2, FIG. 3 shows a surface area A, within oval 26, of the input beam 20 on the first diffuser 24. Surface area A′, within oval 28, of the diverging beam 20′ on the second diffuser 22 is much larger than that of area A due to expansion of the input beam 20 through the diffuser 24. The diverging beam 20′, with larger surface area, is the extended source input to the second diffuser 22 which expands the beam even greater to define the output beam 20″.

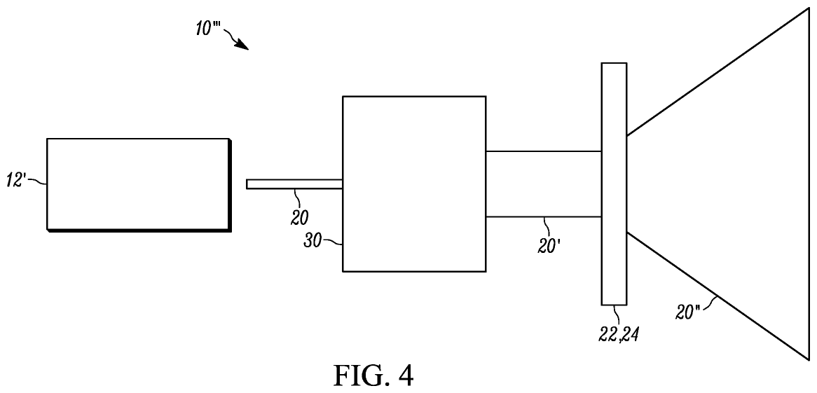

With reference to FIG. 4, in this embodiment, the system 10′″ uses a beam expander 30 as the first beam divergence structure and with a high angle diffuser 22 or low angle diffuser 24 used as the second beam divergence structure. This embodiment is similar to the first embodiment (FIG. 2) in that the second beam divergence structure (diffuser 22 or 24) is the primary beam shaping element. However, the embodiment of FIG. 4 allows for a more compact configuration to expand the beam. The beam expander 30 increases the beam size in a relatively small package while still minimizing the divergence of the beam that hits the second diffuser 22 or 24. This divergence is a primary cause of energy loss and so this embodiment is a good solution to minimize lost energy/low efficiency.

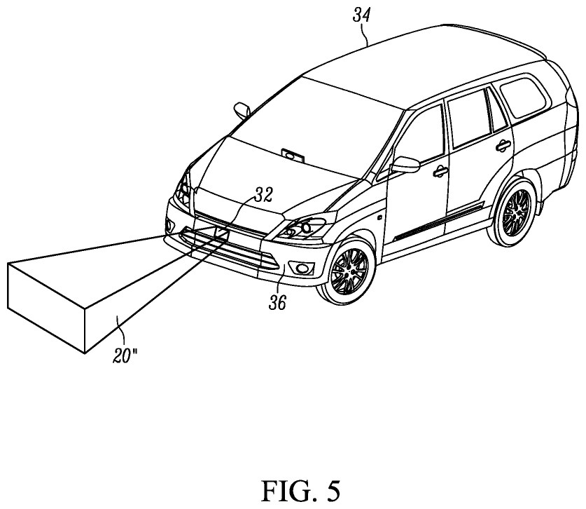

With reference to FIG. 5, the laser system 10′, 10″ or 10′″ is shown employed as the light source of a LIDAR sensor 32 of a vehicle 34. The sensor 32 is typically on the exterior of the vehicle, for example on the front bumper 36, or the side of the vehicle such as between the doors, or on the rear of the vehicle or any other place in or out of the vehicle so as to illuminate an area outside of the vehicle with laser light 20″ and detect the reflection of the laser light from objects disposed in the lighted area.

Advantages of the system 10′, 10″ and 10′″ include: significantly reduced cost and weight by removing large/heavy lens elements; potential for higher efficiency; reduced system length; and makes high power/energy small laser system eye safe by maintaining, for example, Class 1 status (per ANSI and IEC standards). Thus, the system can be operated in public with fewer/zero special control measures, which is a requirement of all LIDAR systems.

A conventional system uses two diffusers in one element to create a more homogeneous illumination pattern by having a large diffusion angle on the front or first surface of the element and a small diffusion angle of the back or second surface the element. However, this conventional system uses a single element with as double surface diffuser that is very costly since one must etch two diffuser surfaces into the single element, which also increases the risk of error in manufacturing. In the embodiments providing two beam divergence structures that have different diffusing properties provides more design freedom and also allows for variable air gap spacing between the two diffusers. For high energy systems, the first divergence structure must be made of glass to withstand the laser energy. Because the beam is expanded from the first element this allows the second divergence structure (e.g., diffuser 22 or 24) to be made of plastic, which is significantly less expensive.

Although the system has been described with reference to a Class 1 laser, the system is applicable to other laser classifications such as, for example, Class 1M.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A laser system comprising:
a laser module constructed and arranged to generate a laser input beam,
a first beam divergence structure constructed and arranged to receive the laser input beam and to expand the laser input beam to a diverging beam,
a second beam divergence structure separate from and spaced from the first beam divergence structure, the second beam divergence structure being constructed and arranged to receive the diverging beam, creating an extended source when incident thereon, and to expand the diverging beam further into an output beam that illuminates an area,
wherein the second beam divergence structure defines a plane that a human eye cannot effectively see past so that the laser system can operate at higher power while maintaining a low laser classification.

2. The laser system of claim 1, wherein the laser module includes a Class 1 laser and wherein the beam divergence structures are constructed and arranged such that a surface area of the second beam divergence structure forms the extended source that is greater than an area created on the first beam divergence structure so that the laser system can operate at higher power while maintaining the Class 1 laser status.

3. The laser system of claim 1, wherein the first beam divergence structure is a high angle diffuser and the second beam divergence structure is a low angle diffuser.

4. The laser system of claim 3, wherein the high angle diffuser is made of glass and the low angle diffuser is made of plastic.

5. The laser system of claim 1, wherein the first beam divergence structure is a low angle diffuser and the second beam divergence structure is a high angle diffuser.

6. The laser system of claim 5, wherein the low angle diffuser is made of glass and the high angle diffuser is made of plastic.

7. The laser system of claim 1, wherein the first beam divergence structure is beam expander and the second beam divergence structure is a high angle diffuser or a low angle diffuser.

8. The laser system of claim 7, wherein the beam expander is made of glass and the second beam divergence structure is made of plastic.

9. The laser system of claim 1, wherein the laser module includes a ND:YAG crystal.

10. The laser system of claim 1, in combination with a LIDAR sensor mounted on a vehicle, the laser system being the light source of the LIDAR system.

11. A method of providing a laser with maximum allowable laser energy, the method comprising the steps of:
providing a laser module that generates a laser input beam,
expanding the laser input beam by a first divergence structure into a diverging beam,
receiving the diverging beam by a second divergence structure, creating an extended source when incident on the second beam structure, and expanding the diverging beam further into an output beam that illuminates an area,
wherein the second beam divergence structure is separate from and spaced from the first beam divergence structure and the second beam divergence structure defines a plane that a human eye cannot effectively see past so that the laser system can operate at higher power while maintaining a low laser classification.

12. The method of claim 11, wherein the first beam divergence structure is a high angle diffuser and the second beam divergence structure is a low angle diffuser.

13. The method of claim 12, wherein the high angle diffuser is made of glass and the low angle diffuser is made of plastic.

14. The method of claim 11, wherein the first beam divergence structure is a low angle diffuser and the second beam divergence structure is a high angle diffuser.

15. The method of claim 14, wherein the low angle diffuser is made of glass and the high angle diffuser is made of plastic.

16. The method claim 11, wherein the first beam divergence structure is beam expander and the second beam divergence structure is a high angle diffuser or a low angle diffuser.

17. The method of claim 16, wherein the beam expander is made of glass and the second beam divergence structure is made of plastic.

18. The method of claim 16, wherein the laser module is a Class 1 laser including a ND:YAG crystal.

19. The method of claim 11, further comprising:
incorporating the laser system as a light source of a LIDAR sensor,

20. The method of claim 19, further comprising:
Incorporating the LIDAR sensor on a vehicle.
